(19) United States
(12) Patent Application Publication
(10) Pub. No.: US 2022/0164886 A1
(43) Pub. Date: May 26, 2022

(54) ARTIFICIAL INTELLIGENCE FINANCIAL ANALYSIS AND REPORTING PLATFORM

(71) Applicant: VFD SAAS Technology, Ltd., Twickenham (GB)

(72) Inventor: Alfonso Fernandez Stuyck, Twickenham (GB)

(73) Assignee: VFD SAAS Technology, Ltd., Twickenham (GB)

(21) Appl. No.: 17/533,847

(22) Filed: Nov. 23, 2021

Related U.S. Application Data
(60) Provisional application No. 63/117,579, filed on Nov. 24, 2020.

(51) Int. Cl. G06Q 40/06

(52) U.S. Cl. CPC G06Q 40/06

(57) ABSTRACT

A computer-implemented method performed by an artificial intelligence (AI) financial analysis and reporting platform is disclosed. The method comprises: analyzing a first set of financial data from a first period of time to compare the first set of financial data to a second set of financial data from a second period of time; and generating a report on a financial performance of the entity, where the report includes an explanation of differences between the first set of financial data and the second set of financial data. Additionally, in some embodiments, AI financial analysis and reporting platform may perform analysis to detect anomalies and trends in financial data. AI financial analysis and reporting platform may also generate a bankruptcy/financial distress prediction model to predict whether an entity will experience bankruptcy or financial distress.

### CROSS-REFERENCE TO RELATED APPLICATIONS

This application claims priority to and the benefit of U.S. Provisional Application Patent Ser. No. 63/117,579, filed Nov. 24, 2020, titled “Artificial Intelligence Financial Analysis and Reporting Platform”. The entire disclosure of the above-referenced application is hereby incorporated by reference

### BACKGROUND

Financial management of companies includes the analysis on a monthly basis of the company accounts (Profit and Loss, Balance Sheet and Cashflow Statement) and the preparation of reports for senior management summarizing financial performance and concluding what has happened to the financial performance of the company (e.g. what is the profitability of the company and how this profitability has been obtained, or how financial parameters have changed versus the previous year and how these parameters compared to expectations (budget)). Proper financial management (i) allows for a better understanding of the company's performance, strength and profit drivers (ii) helps to make better informed decisions based on evidence and data and (iii) allows for a proactive financial management, avoiding surprises, liquidity problems and, potentially, bankruptcy.

When auditing or analyzing companies to be purchased or to invest in, financial advisors conduct financial analysis of the company's historic financials and write reports summarizing the historic financial performance and key financial findings. This is called financial due diligence. These analyses and reports are used by the potential buyers of, or investors in, a company as part of their decision to buy a company and assign a price to the company.

### SUMMARY

Representative embodiments set forth herein disclose various techniques for enabling a system and method for conducting automated financial analysis and preparing instant financial reports to be shown on a computer screen and to be printed.

In one embodiment, a computer-implemented method performed by an artificial intelligence (AI) financial analysis and reporting platform is disclosed. The method comprises: receiving a first set of historic monthly financial data associated with an entity, the first set of financial data being in a first format of an accounting system of the entity or an Excel template; transforming the first set of financial data from the first format to a second format of the AI financial analysis and reporting platform; analyzing the second format of financial data to understand financial performance and strength of one period (e.g. July 2020 or January to July 2020) and compare it with a previous year or a budget; and generating a report summarizing financial performance and status of the period and differences versus previous year and budget.

In one embodiment, an artificial intelligence (AI) financial analysis and reporting platform is disclosed. The AI financial analysis and reporting platform comprises: a memory device containing stored instructions; and a processing device communicatively coupled to the memory device. The processing device executes the stored instructions to: receive a first set of historic monthly financial data associated with an entity, the first set of financial data being in a first format of an accounting system of the entity or an Excel template; transform the first set of financial data from the first format to a second format of the AI financial analysis and reporting platform; analyze the second format of financial data to understand financial performance and strength of one period (e.g. July 2020 or January to July 2020) and compare it with a previous year or a budget; and generate a report summarizing financial performance and status of the period and differences versus previous year and budget.

In one embodiment, a computer readable media storing instructions that are executable by a processor to cause a processing device to execute operations is disclosed. The processing device is caused to: receive a first set of historic monthly financial data associated with an entity, the first set of financial data being in a first format of an accounting system of the entity or an Excel template; transform the first set of financial data from the first format to a second format of an AI financial analysis and reporting platform; analyze the second format of financial data to understand financial performance and strength of one period (e.g. July 2020 or January to July 2020) and compare it with a previous year or a budget; and generate a report summarizing financial performance and status of the period and differences versus previous year and budget.

### BRIEF DESCRIPTION OF THE DRAWINGS

For a detailed description of example embodiments, reference will now be made to the accompanying drawings in which:

FIG. 1 shows a block diagram of an example of an artificial intelligence (AI) financial analysis and reporting platform, in accordance with various embodiments;

FIG. 2A shows a method for analyzing a financial performance of an entity, in accordance with various embodiments;

FIG. 2B shows a method for analyzing a financial performance of an entity, in accordance with various embodiments;

FIGS. 3-7 provide exemplary embodiments of a report generated by AI financial analysis and reporting platform, in accordance with various embodiments;

FIGS. 8-17 provide exemplary embodiments of additional reports generated by AI financial analysis and reporting platform, in accordance with various embodiments;

FIG. 18 illustrates a detailed view of a computing device that can represent the computing devices of FIG. 1 used to implement the various platforms and techniques described herein, according to some embodiments.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

The term “entity” may refer to a company, a corporation, an organization, a club, an association, an individual, etc. The entity may be public or private.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Investors/Owners of companies and lenders to those companies face the risk that companies they invest in or lend to face financial distress or go bankrupt. They would benefit from a financial distress/bankruptcy prediction model that can tell them the probability of an entity going bankrupt. This will allow them to, proactively, flag the situation/concern, identify why the company may be in trouble and take appropriate action, potentially avoiding financial distress or bankruptcy.

Some embodiments described herein are directed to a financial analysis and reporting tool. For example, embodiments described herein include an artificial intelligence (AI) financial analysis and reporting platform that enables users to improve their financial management and strategic decision making through the better understanding of an entity's financial performance and status. For example, the AI financial analysis and reporting platform helps users or entities better understand their financial performance and predicts future financial performance for users. This allows users to be proactive (rather than reactive) in the way they manage their finances and to make better strategic and financial decisions.

More specifically, in some embodiments, the AI financial analysis and reporting platform may analyze monthly financial statements of companies (e.g., profit and loss, balance sheet, cash flow, etc.) and produce instant financial reports. Further, in some embodiments, the AI financial analysis and reporting platform may incorporate and present automated written commentary (i.e., an explanation of financial performance and/or a description of a financial situation) in an intuitive and visual/graphical manner. Still yet, in some embodiments, the AI financial analysis and reporting platform may also develop a machine learning model that aims to predict bankruptcy/financial distress, earning shocks (positive or negative) and cash balances. The AI financial analysis and reporting platform may provide an enhanced user interface including a financial report to an application (e.g., stand-alone or executing within a web browser) executing on a computing device of a user. The enhanced user interface may include dynamically selected and generated graphical user interface elements that are selected and generated based on analysis of the financial data of various entities. For example, the user interface may include graphical user interface elements based on trends and/or anomalies identified in the financial data of a company. In some embodiments, trends may refer to an evolution of a financial parameter in time. For example, a trend may include whether a parameter (e.g., EBITDA) is growing, declining, or stable when observed on a monthly or last-twelve-month (LTM) basis. In some embodiments, the trends may also refer to changes in financial data between two time periods that does not satisfy a threshold (e.g., profits are increasing at a certain rate year over year). The anomalies may refer to unusual changes in financial data between two time periods that satisfies a threshold (e.g., marketing costs grew unusually this month by $100,000, or receivables decreased unusually this month by $35,000). The anomalies may refer to unusual spike or decline of certain data at a given time (e.g., profits was $100 for this month). Furthermore, the anomalies may refer to certain data at a given time being unusually big or small when compared to past periods (e.g. marketing expenses are unusually high when compared to the past). The report including the graphical user interface elements and explanations of differences and anomalies may be presented in a single user interface of the application. Accordingly, the user does not need to switch between user interfaces, websites, accounting system applications, or the like to view the financial report and to glean useful information pertaining to the financial performance and status of the entities. Centralizing the pertinent data in a single user interface may thus reduce computing resources by reducing the number of applications that need to be executed on computing device to view the pertinent data. As a result, a user's experience of using the computing device may be improved.

The disclosure may provide various technical solutions, such as transforming data in various formats of accounting systems to a uniform format used by the AI financial analysis and reporting platform. The transformation may be performed by one or more machine learning models that map schemas including the various formats of the accounting systems to a schema including a generic format, and map the data having the schema including the generic format to the format used by the AI financial analysis and reporting platform. In some embodiments, one or more machine learning models may be trained to map the schemas including various formats of the accounting systems to the schema including the format used by the AI financial analysis and reporting platform. This transformation enables the AI financial analysis and reporting platform to process and analyze data in any format from any suitable accounting system. Further, the AI financial analysis and reporting platform may enable interoperability with the accounting systems by connecting to one or more application programming interfaces (APIs) of the accounting systems. The APIs may expose services having certain function calls that enable the AI financial analysis and reporting platform to obtain the schemas including the formats of data used by the accounting systems and to obtain financial data about the various entities.

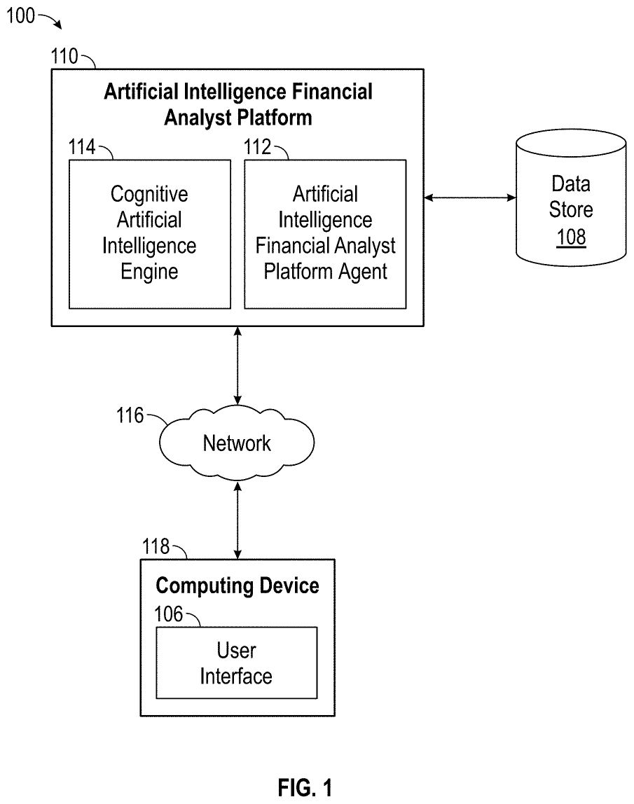

A method and a system for an AI financial analysis and reporting platform are disclosed herein. FIG. 1 shows a block diagram of an exemplary embodiment of an AI financial analysis and reporting platform 110, in accordance with various embodiments described herein. As further shown in FIG. 1, AI financial analysis and reporting platform 110 includes an AI financial analysis and reporting platform agent 112, a cognitive AI engine 114, and an accounting system 220. For purposes of this discussion, the AI financial analysis and reporting platform 110 provides services in the financial industry, thus the examples discussed herein are associated with the financial industry. However, any service industry can benefit from the disclosure herein, and thus the examples associated with the financial industry are not meant to be limiting.

AI financial analysis and reporting platform 110 may include several computing devices, where each computing device, respectively, includes at least one processor, at least one memory, and at least one storage (e.g., a hard drive, a solid-state storage device, a mass storage device, and a remote storage device). The individual computing devices can represent any form of a computing device such as a desktop computing device, a rack-mounted computing device, and a server device. The foregoing example computing devices are not meant to be limiting. On the contrary, individual computing devices implementing AI financial analysis and reporting platform 110 can represent any form of computing device without departing from the scope of this disclosure.

In various embodiments, the several computing devices executing within AI financial analysis and reporting platform 110 are communicably coupled by way of a network/bus interface. Furthermore, AI financial analysis and reporting platform agent 112 and cognitive AI engine 114 may be communicably coupled by one or more inter-host communication protocols. In some embodiments, AI financial analysis and reporting platform agent 112 and cognitive AI engine 114 may execute on separate computing devices. Still yet, in some embodiments, AI financial analysis and reporting platform agent 112 and a cognitive AI engine 114 may be implemented on the same computing device or partially on the same computing device, without departing from the scope of this disclosure.

The several computing devices work in conjunction to implement components of AI financial analysis and reporting platform 110 including AI financial analysis and reporting platform agent 112 and cognitive AI engine 114. AI financial analysis and reporting platform 110 is not limited to implementing only these components, or in the manner described in FIG. 1. That is, AI financial analysis and reporting platform 110 can be implemented, with different or additional components, without departing from the scope of this disclosure. The example AI financial analysis and reporting platform 110 illustrates one way to implement the methods and techniques described herein.

In FIG. 1, AI financial analysis and reporting platform agent 112 represents a set of instructions executing within AI financial analysis and reporting platform 110 that implement a client-facing component of AI financial analysis and reporting platform 110. AI financial analysis and reporting platform agent 112 may be configured to enable interaction between a user and AI financial analysis and reporting platform 110 via a user interface 106. Various user interfaces may be provided to computing devices communicating with AI financial analysis and reporting platform agent 112 executing in AI financial analysis and reporting platform 110. For example, a user interface 106 may be presented in a standalone application executing on a computing device 118 or in a web browser as website pages. In some embodiments, AI financial analysis and reporting platform agent 112 may be installed on computing device 118. In some embodiments, computing device 118 may communicate with AI financial analysis and reporting platform 110 in a client-server architecture. In some embodiments, AI financial analysis and reporting platform agent 112 may be implemented as computer instructions as an application programming interface.

Computing device 118 represents any form of a computing device, or network of computing devices, e.g., a personal computing device, a smart phone, a tablet, a wearable computing device, a notebook computer, a media player device, and a desktop computing device. Computing device 118 includes a processor, at least one memory, and at least one storage. In some embodiments, an employee or representative of an entity may use user interface 106 to input a given text posed in natural language (e.g., typed on a physical keyboard, spoken into a microphone, typed on a touch screen, or combinations thereof) and interact with AI financial analysis and reporting platform 110, by way of AI financial analysis and reporting platform agent 112. The AI financial analysis and reporting platform agent 112 may implement natural language processing to receive data pertaining to the text, parse it, understand it, and provide a response.

As further shown in FIG. 1, a network 116 communicatively couples various devices, including AI financial analysis and reporting platform 110 and computing device 118. The network 116 can include local area network (LAN) and wide area networks (WAN). The network 116 can include wired technologies (e.g., Ethernet®) and wireless technologies (e.g., Wi-Fi®, code division multiple access (CDMA), global system for mobile (GSM), universal mobile telephone service (UMTS), Bluetooth®, and ZigBee®. For example, computing device 118 can use a wired connection or a wireless technology (e.g., Wi-Fi®) to transmit and receive data over network 116.

With continued reference to FIG. 1, cognitive AI engine 114 represents a set of instructions executing within AI financial analysis and reporting platform 110 that is configured to collect, analyze, and process financial information data associated with an entity from various sources and entities. Assume for the sake of illustration a user associated with computing device 118 is an employee of the entity (e.g., bank). In some embodiments, the user, using computing device 118 (e.g., a desktop computer or a tablet), may provide financial data associated with the entity to AI financial analysis and reporting platform 110. For example, in some embodiments, monthly financial data may be uploaded (e.g., from a spreadsheet template) into AI financial analysis and reporting platform 110. AI financial analysis and reporting platform 110 may be able to be linked to the entity's accounting system (e.g., Xero, QuickBooks, Sage, etc.), such as accounting system 220, and obtain financial data directly from the accounting system. In some embodiments, AI financial analysis and reporting platform 110 may be linked to accounting system 220 which may be a non-cloud based accounting software solution. Alternatively, accounting system 220 may be a cloud-based accounting software solution. For example, accounting systems (e.g., accounting system 220) may provide application programming interfaces (APIs) that use services exposing various function calls. The AI financial analysis and reporting platform 110, which is hosted by a server or in a cloud-based computing system separate from the accounting systems, may connect to, via network 116, to the services included in the APIs and execute the function calls to obtain the financial data, and/or schemas including the various formats of the data stored in the accounting systems. Thus, in some embodiments, AI financial analysis and reporting platform 110 may (e.g., using an application programming interface (API)) connect to one or more accounting systems and retrieve the financial data. This provides a technical solution and may eliminate the need for double entry (e.g., exporting the financial data from an accounting system to Excel and then transforming the Excel data into the AI financial analysis and reporting platform 110 spreadsheet template). Cognitive AI engine 114 may also collect financial data from other entities. For example, AI financial analysis and reporting platform 110 may receive financial information electronically from one or more entities via network 116. Further, the AI financial analysis and reporting platform 110 may perform web-crawling techniques to search webpages associated with various entities. The AI financial analysis and reporting platform 110 may perform screen-scraping techniques and/or use optical character recognition to obtain financial data about the entities from the various webpages.

In some embodiments, the data may be in an accounting system's data format and need to be transformed into a data format of AI financial analysis and reporting platform 110. Cognitive AI engine 114 may use natural language processing (NLP) and data mining and pattern recognition technologies to collect and process information provided in different financial information formats. For example, cognitive AI engine 114 may use NLP to extract and interpret hand written notes and text. As another example, cognitive AI engine 114 may use imaging extraction techniques, such as optical character recognition (OCR) and/or use a machine learning model trained to identify and extract certain financial information. OCR refers to electronic conversion of an image of printed text into machine-encoded text and may be used to digitize financial information. As another example, pattern recognition and/or computer vision may also be used to extract information from financial information resources. Computer vision may involve image understanding by processing symbolic information from image data using models constructed with the aid of geometry, physics, statistics, and/or learning theory. Pattern recognition may refer to electronic discovery of regularities in data through the use of computer algorithms and with the use of these regularities to take actions such as classifying the data into different categories and/or determining what the symbols represent in the image (e.g., words, sentences, names, numbers, identifiers, etc.). Finally, cognitive AI engine 114 may use NLU techniques to process unstructured data using text analytics to extract entities, relationships, keywords, semantic roles, and so forth.

In some embodiments, cognitive AI engine 114 may use the same technologies to synthesize data from various information sources and entities, while weighing context and conflicting evidence. Still yet, in some embodiments, cognitive AI engine 114 may use one or more machine learning models. The one or more machine learning models may be generated by a training engine and may be implemented in computer instructions that are executable by one or more processing device of the training engine, the cognitive AI engine 114, another server, and/or the computing device 118. To generate the one or more machine learning models, the training engine may train, test, and validate the one or more machine learning models. The training engine may be a rackmount server, a router computer, a personal computer, a portable digital assistant, a smartphone, a laptop computer, a tablet computer, a camera, a video camera, a netbook, a desktop computer, a media center, or any combination of the above. The one or more machine learning models may refer to model artifacts that are created by the training engine using training data that includes training inputs and corresponding target outputs. The training engine may find patterns in the training data that map the training input to the target output, and generate the machine learning models that capture these patterns. For example, the one or more machine learning models may receive data in one format as an input and output the data in the format of AI financial analysis and reporting platform 110. The one or more machine learning models may be trained to receive financial data from two different periods of time and identify differences in the financial data. The one or more machine learning models may be trained to receive the differences in the financial data from two different periods of time and identify trends and/or anomalies in the financial data based on the severity of the differences in the financial data. The one or more machine learning models may be trained to receive trends and/or anomalies in the financial data and select and generate graphical user interface elements (e.g., type (bar graph, pie chart, line chart, etc.), size, color, and/or generated explanation of the trend and/or anomaly, etc.)) to include in a user interface.

In some embodiments, the one or more machine learning models may be trained to map a set of schemas including a set of formats used by accounting systems to a generic schema including a generic format. The one or more machine learning models may be trained to map the generic schema including the generic format to a schema including the second format of the AI financial analysis and reporting platform 110. The one or more machine learning models may be trained to generate the explanation of the differences between a first set of financial data and a second set of financial data of an entity from two different time periods. The explanation of the differences may be generated based on the comparison of the first set of financial data to the second set of financial data associated with the entity, and based on the differences identified during the comparison, the explanation of the differences may be generated using a set of template sentences, phrases, words, constructs, or some combination thereof. Further, the explanation may be color coded if a trend/difference is positive or negative, if an anomaly is positive or negative, or the like. Anomaly as used herein refers to deviations from a mean of historical financial data associated with an entity and to calculate the mean one or more historic periods of financial data associated with an entity may be used in the calculation.

In some embodiments, the one or more machine learning models may be trained to determine when a difference in financial data qualifies as an anomaly (e.g., a deviation from a mean of historical financial data or when the difference satisfies a threshold (e.g., the difference is more than a certain percent, value, amount, etc. change from a previous time period or from an average of past periods' values)) and/or as a trend (e.g., a general movement over time of a statistically detectable change in a financial parameter and/or when there is a difference detected but it does not satisfy the threshold (e.g., the difference is less than a certain percent, value, amount, etc. change from a previous time period)). The one or more machine learning models may be trained to transmit a notification to a computing device associated with the entity. The notification includes a description of the anomaly and provides.

In some embodiments, the one or more machine learning models may be trained to generate the report for presentation on a user interface by selecting graphical user interface elements representing trends, anomalies, or some combination thereof. The trends include changes in financial categories, and the anomalies include changes in financial categories that satisfy a threshold, generating the graphical user interface elements to represent data based on the differences between the first set of financial data and the second set of financial data. The one or more machine learning models may be trained to cause the graphical user interface elements to be presented on a single user interface of the AI financial analysis and reporting platform.

Cognitive AI engine 114 may include a machine learning model generator and one or more machine learning models. The machine learning model generator may be configured to generate machine learning models to facilitate the analysis of financial information provided to AI financial analysis and reporting platform 110. Further, the machine learning models may be deployed in cognitive AI engine 114. For example, the one or more machine learning models may be trained to predict bankruptcy/financial distress, earning shocks (positive or negative) and cash balances. For example, financial information associated with one or more companies may be input as training data to the one or more machine learning models. The information may pertain to facts, deviations, properties, attributes, concepts, conclusions, risks, correlations etc. associated with the financial data provided to the model. Keywords, phrases, sentences, cardinals, numbers, values, objectives, nouns, verbs, concepts, and so forth may be specified (e.g., labeled) in the information such that the machine learning models learn which ones are associated with the financial information. The information may specify predicates that correlates the financial information in a logical structure such that the machine learning models learn the logical structure associated with bankruptcy or financial distress. Other sources including information pertaining to other types of financial information (e.g., an entity's performance based on Securities and Exchange Commission (SEC) filings, reputable analyst reports, and information from the entity website) may be input as training data to the one or more machine learning models.

In some embodiments, as described, the machine learning model generator may be configured to generate a bankruptcy/financial distress prediction model. For example, the machine learning model generator may include a machine learning algorithm. The machine learning algorithm may provide financial information (e.g., sales, cost of sales, overheads, profits, etc.) of other companies who experienced bankruptcy or financial distress as input and be processed by the machine learning model generator to generate the bankruptcy/financial distress prediction model.

For example, the machine learning model generator may provide financial information to a machine learning algorithm. Machine learning model generator may also include a machine learning application that implements the machine learning algorithm to the bankruptcy/financial distress prediction model. When the machine learning algorithm is implemented, it may find patterns in the financial information to identify the financial information that is associated with bankruptcy or financial distress, and output a model that predicts bankruptcy or financial distress for an entity based on financial information associated with the company. The bankruptcy/financial distress prediction model may be generated using any suitable techniques, including supervised machine learning model generation algorithms such as supervised vector machines (SVM), linear regression, logistic regression, naïve Bayes, linear discriminant analysis, decision trees, k-nearest neighbor algorithm, neural networks, recurrent neural network, etc. In some embodiments, unsupervised learning algorithms may be used such as clustering or neural networks.

Note that the bankruptcy/financial distress prediction model may be generated in various forms. In accordance with one embodiment, the bankruptcy/financial distress prediction model may be generated according to a suitable machine-learning algorithm mentioned elsewhere herein or otherwise known. For example, the bankruptcy/financial distress prediction model may receive financial information associated with the company as input data and try to predict labels like “bankrupt” or “financially healthy.” As another example, the bankruptcy/financial distress prediction model may receive financial information associated with the entity as input data and try to determine the likelihood that the entity will experience bankruptcy or financial distress.

Alternatively, or in addition to, the machine model generator may implement an artificial neural network learning algorithm to generate the bankruptcy/financial distress prediction model as a neural network that is an interconnected group of artificial neurons. The neural network may be presented financial information of the entity to identify financial information of the entity that is similar to the financial information of other companies that experienced bankruptcy or financial distress.

Further, AI financial analysis and reporting platform 110 is configured to analyze financial data associated with an enterprise or organization. For example, a user may select, via user interface 106, a date range to be analyzed (e.g., January 2020 to September 2020) and AI financial analysis and reporting platform 110 may analyze data from that period. In addition, AI financial analysis and reporting platform 110 may as well as provide historic trend charts that take into account data from earlier periods (e.g., from January 2015). More specifically, AI financial analysis and reporting platform 110 is configured to provide monthly performance analysis. For example, the performance of a last month is compared to the same month of the previous year across several financial parameters (e.g., sales, cost of sales, overheads, profits, etc.). Additionally, AI financial analysis and reporting platform 110 is configured to provide year-to-date performance analysis. For example, AI financial analysis and reporting platform 110 may analyze the cumulative performance of the months from the start of the year to present (e.g. January 2020 to September 2020) and compare this period to the same period of one or more previous years across several financial parameters (e.g. sales, cost of sales, overheads, profits, etc.). In some embodiments, this functionality of AI financial analysis and reporting platform 110 may involve using advanced analytics and AI algorithms to determine commentary and to select the data to populate the charts. Different analysis that may be performed by AI financial analysis and reporting platform 110 may include vertical analysis, horizontal analysis, leverage analysis, growth rates, profitability analysis, liquidity analysis, efficiency analysis, cash flow, rates of return, valuation analysis, scenario and sensitivity analysis, variance analysis, etc.

After analyzing the data, AI financial analysis and reporting platform 110 may generate a report including a summary of the analysis. For example, a report may utilize color coding in charts and written explanations, such as red/orange to indicate bad and green/blue to indicate good. The report generated by analysis and comparison of this year's performance (or any selected period) versus previous years can include tables, charts (e.g., diamond charts, bridge charts, etc.), and written explanation. In some embodiments, user interface 106 may include a dashboard that a user can use to drill down into financial data associated with an entity. Additionally, the user may determine which analysis services (e.g., represented by graphical user interface elements) provided by AI financial analysis and reporting platform 110 to add or remove from the dashboard.

In some embodiments, AI financial analysis and reporting platform 110 may determine if an entity will break a financial covenant or regulations. For example, AI financial analysis and reporting platform 110 may generate a formula to represent the covenant and apply an entity's financial information to the formula to determine if a covenant will be broken. In Some embodiments, a machine learning model may be generated to predict when an entity will break the covenant. The banks' covenants may be obtained by performing function calls to APIs provided by the banks.

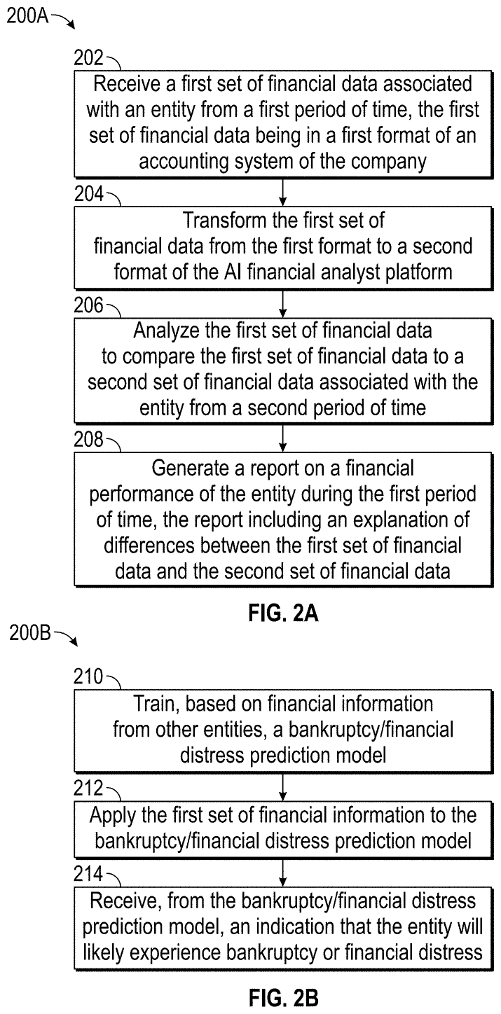

To explore this further, FIG. 2A will now be described. FIG. 2A shows a method 200A for analyzing a financial performance of an entity. The method 200A is performed by processing logic that may include hardware (circuitry, dedicated logic, etc.), software (such as is run on a general purpose computer system or a dedicated machine), or a combination of both. The method 200A and/or each of their individual functions, routines, subroutines, or operations may be performed by one or more processors of a computing device (e.g., any component of FIG. 1, such as AI financial analysis platform 110). In certain implementations, the method 200A may be performed by a single processing thread. Alternatively, the method 200A may be performed by two or more processing threads, each thread implementing one or more individual functions, routines, subroutines, or operations of the methods.

For simplicity of explanation, the method 200A is depicted and described as a series of operations. However, operations in accordance with this disclosure can occur in various orders and/or concurrently, and with other operations not presented and described herein. For example, the operations depicted in the method 200A may occur in combination with any other operation of any other method disclosed herein. Furthermore, not all illustrated operations may be required to implement the method 200A in accordance with the disclosed subject matter. In addition, those skilled in the art will understand and appreciate that the method 200A could alternatively be represented as a series of interrelated states via a state diagram or events.

As shown in FIG. 2A, method 202 beings at step 202. At step 202, financial data associated with an entity is received, where the financial data is in a first format of an accounting system of the entity. For example, as described with reference to FIG. 1, AI financial analysis and reporting platform agent 112 may receive monthly historical financial data associated with an entity. The financial data may be in a format compatible with an accounting system of the entity (e.g., Xero, QuickBooks, Sage, etc.). The financial data may include information associated with profit and loss, balance sheet, cash flow, etc. The AI financial analysis and reporting platform agent 112 may receive the financial data from a user of computing device 118. Alternatively, or in addition to, AI financial analysis and reporting platform agent 112 may store the financial data in a data store 108 for later access. For example, in some embodiments, financial data may be uploaded (e.g., from a spreadsheet template) into AI financial analysis and reporting platform agent 112. In some embodiments, AI financial analysis and reporting platform agent 112 may be able to be linked to the entity's accounting system and obtain financial data directly from the accounting system. In some embodiments, AI financial analysis and reporting platform agent 112 may (e.g., using an application programming interface (API)) connect to one or more accounting systems and retrieve the financial data.

At step 204, the financial data is transformed from the first format to a second format of the AI financial analysis and reporting platform. For example, with continued reference to FIG. 1, AI financial analysis and reporting platform 110 transforms the financial data from the first format to a second format of the AI financial analysis and reporting platform 110. The second format may be a format compatible with AI financial analysis and reporting platform 110.

At step 206, a first set of financial data from a first period of time is analyzed to compare the first set of financial data to a second set of financial data from a second period of time, where the first set of financial and the second set of financial data comprises data from the received financial data. For example, with continued reference to FIG. 1, AI financial analysis and reporting platform 110 may analyze the first set of financial data to compare the first set of financial data to the second set of financial data from the second period of time. To help further illustrate, a user may select, via user interface 106, a date range to be analyzed (e.g., January 2020 to September 2020) and AI financial analysis and reporting platform 110 may analyze data from that period. Additionally, AI financial analysis and reporting platform 110 may analyze the financial data by comparing the financial data from the first period of time to financial data from another time period (e.g., January 2019 to September 2019). This may include the comparison of several financial parameters (e.g., sales, cost of sales, overheads, profits, etc.).

At step 208, a report on a financial performance of the entity during the first period of time is generated. The report includes an explanation of differences between the first set of financial data and the second set of financial data. For example, with continued reference to FIG. 1, AI financial analysis and reporting platform 110 may generate a report on a financial performance of the entity during the first period of time. For example, the report will also include an anomalies section, a what-if scenarios section, a trend analysis section and a bankruptcy/financial distress prediction section. The report may be provided to a user of computing device 118 via user interface 106. After the report is generated, it may also be distributed to a user by email, text message, voicemail, and/or automated recording.

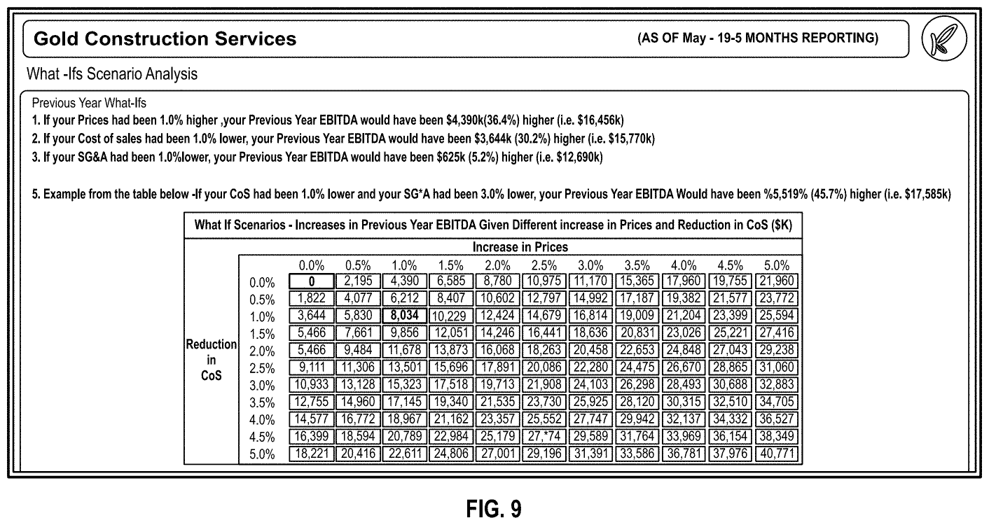

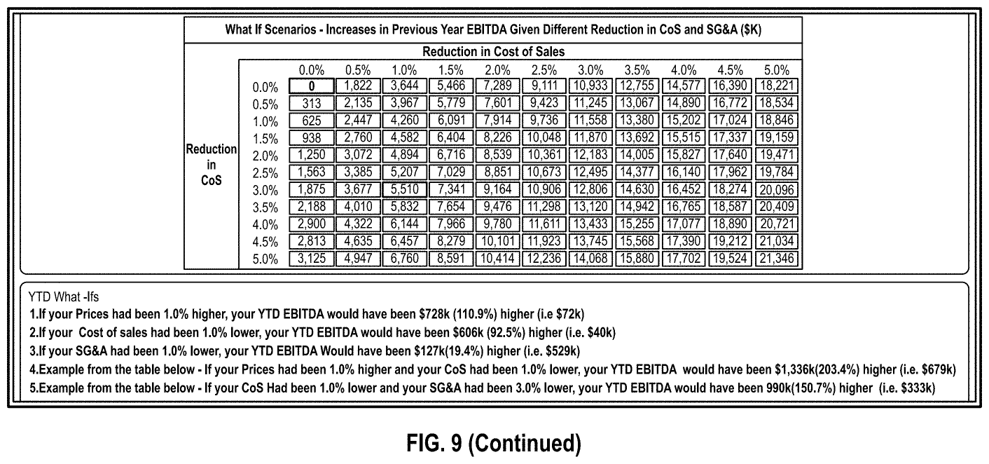

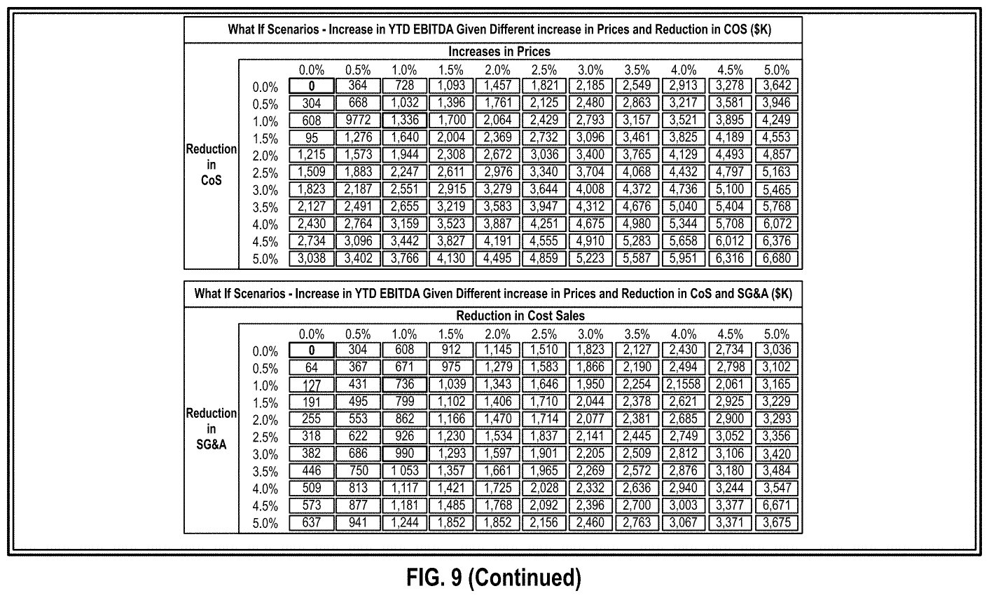

In some embodiments, AI financial analysis and reporting platform 110 may generate recommendations to improve the financial performance of the entity based on the analysis of the financial data and the report may include the recommendations. For example, with reference to FIG. 9, a recommendation to improve the financial performance may include: “If your prices had been 1.0% higher, your previous year EBITDA would have been $4,390 k (36.4%) higher (i.e. $16,456 k).” In some embodiments, recommendations or explanations may be generated using a coded system. For example, the system may include assigning a binary value to certain conditions. For example, a condition may be “is the EBITDA larger than last year.” If the condition is satisfied, then a value of one is assigned to the condition; otherwise a value of zero may be assigned. This may be performed for several conditions (e.g., six or seven conditions) and text including an explanation or recommendation may correspond to a combination of binary values assigned.

FIG. 2B will now be described. FIG. 2B shows a method 200B for predicting if an entity will experience bankruptcy or financial distress. The method 200B may be performed in a similar manner as the method 200A of FIG. 2A. As shown in FIG. 2B, method 200B begins at step 210. At step 210, a bankruptcy/financial distress prediction model is trained based on financial information from other companies. For example, as described with reference to FIG. 1, the machine learning model generator of cognitive AI engine 114 may train the bankruptcy/financial distress prediction model based on financial information (e.g., sales, cost of sales, overheads, profits, etc.) of other companies.

At step 212, the financial data is applied to the bankruptcy/financial distress prediction model. For example, as described with reference to FIG. 1, cognitive AI engine 114 applies financial information of the entity to the bankruptcy/financial distress prediction model by providing the financial information of the entity to the bankruptcy/financial distress prediction model.

At step 214, an indication that the entity exceeds a threshold probability of experiencing bankruptcy or financial distress is received from the bankruptcy/financial distress prediction model. For example, as described with reference to FIG. 1, cognitive AI engine 114 may receive an indication that that the entity exceeds a threshold probability (e.g., over 50%) of experiencing bankruptcy or financial distress is received from the bankruptcy/financial distress prediction model. In some embodiments, cognitive AI engine 114 may generate, in response to receiving the indication, recommendations for the entity to avoid bankruptcy or financial distress and wherein the report includes the recommendations.

Cognitive AI engine 114 is configured to update the bankruptcy/financial distress prediction model to account for financial data received by AI financial analysis and reporting platform 110. For example, cognitive AI engine 114 may update, based on the first set of financial information, the bankruptcy/financial distress prediction model. Cognitive AI engine 204 may maintain the bankruptcy/financial distress prediction model by continuously retraining the bankruptcy/financial distress prediction model based on entity financial data.

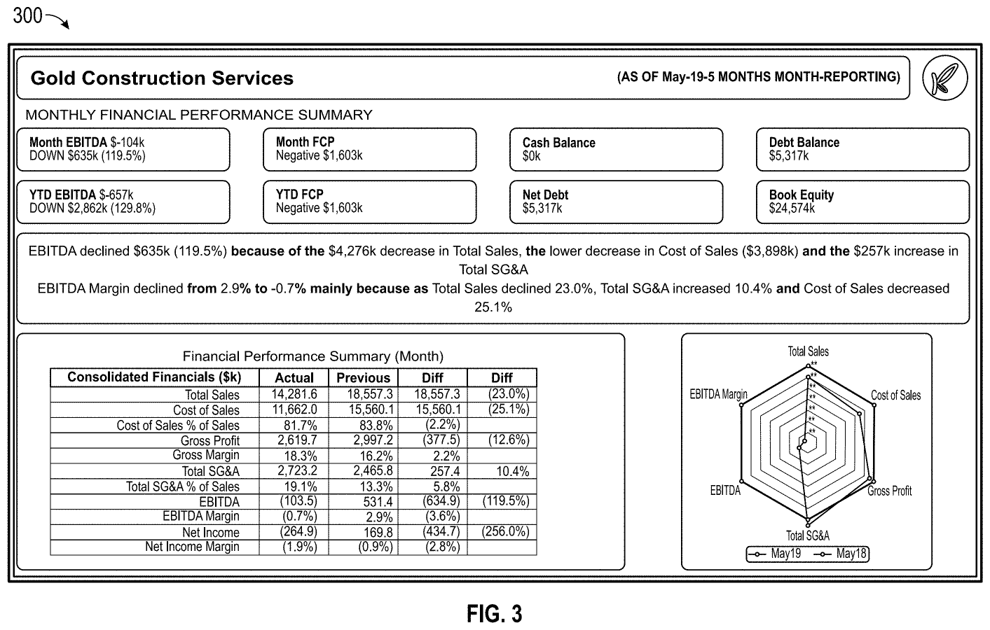

FIGS. 3-7 provide embodiments of a report generated by AI financial analysis and reporting platform 110. Each of the reports may be dynamically generated (e.g., via one or more machine learning models) to include certain graphical user interface elements (e.g., charts, text, etc.) based on preferences, trends, anomalies, etc. AI financial analysis and reporting platform agent 112 may provide the report on the financial performance of the entity to user interface 106 to be displayed for a user of computing device 118. For example, FIG. 3 depicts a monthly financial performance summary that includes an automatically generated explanation of profits and profit margins. In FIG. 3, a report 300 includes a color coded explanation that recites a summary and findings of the analysis of AI financial analysis and reporting platform 110: Earnings before interest, taxes, depreciation, and amortization (EBITDA) declined $635 k (119.5%) because of the $4,276 k decrease in total sales, the lower decrease in cost of sales ($3,898 k), and the $257 k increase in total selling, general and administrative expense (SG&A) and EBITDA margin declined from 2.9% to −0.7% mainly because as total sales declined 23.0%, total SG&A increased 10.4% and cost of sales decreased 25.1%. The explanation may be dynamically generated using the coding technique described above with or without templates of phrases, words, sentences, constructs, etc.

EBITDA refers to an entity's earnings before interest, taxes, depreciation, and amortization and is an accounting measure calculated using an entity's earnings, before deducting interest expenses, taxes, depreciation, and amortization, as a proxy for an entity's current operating profitability. SG&A is reported on an income statement as the sum of all indirect selling expenses and all general and administrative expenses (G&A) of an entity. As shown in FIG. 3, report 300 may include other financial performance information, such as free cash flow (FCF), cash balance, net debt, debt balance, book equity, etc.

In some embodiments, report 300 may include identification of which SG&A costs (or overheads) increased or decreased in comparison with previous time periods or which SG&A costs are the largest ones. This can enable a user to identify costs that are growing too fast or are too high and take cost cutting measures. Report 300 may also include comparative tables and charts illustrating the differences between the selected period and the same period from the previous year. For example, as shown in FIG. 3, report 300 includes a monthly financial performance summary that compares financial parameters from the current month to a previous month and highlights the differences in the financial parameters between the current month and the previous month. Report 300 may also include visual representations of the analysis of AI financial analysis and reporting platform 110. Report 300 also includes a diamond chart that provides a user a visual comparison between financial parameters (e.g., EBITDA margin, total sales, EBITDA, total SG&A, gross profits, and cost of sales) from May 2019 and May 2018.

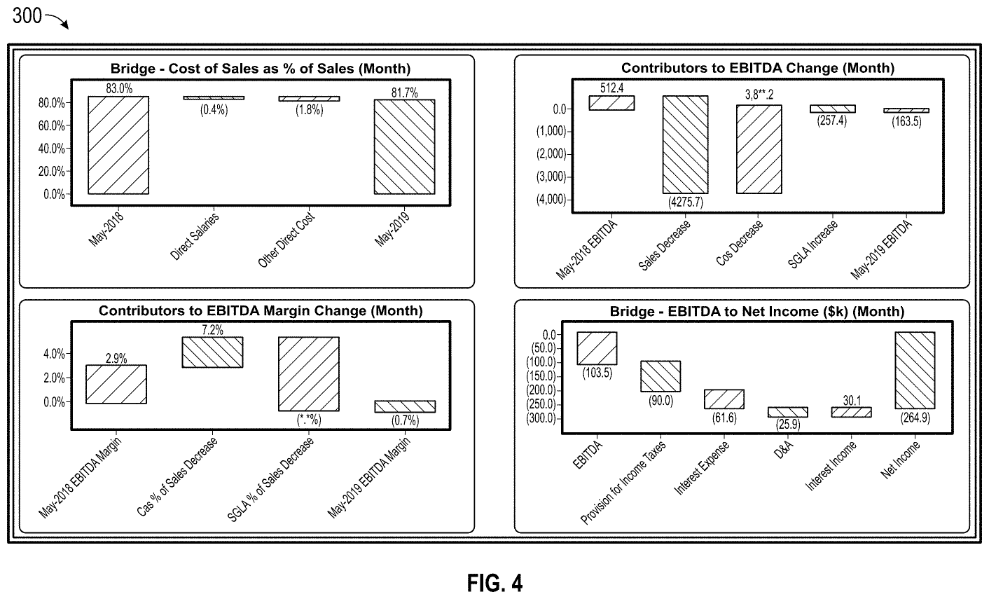

Report 300 may include other visual representations of the analysis of AI financial analysis and reporting platform 110. FIG. 4 provides examples of the analysis of the AI financial analysis and reporting platform 110 described above represented visually in graphs. For example, FIG. 4 depicts bridge charts of the following: Cost of Sales as % of Sales, Contributors to EBITDA Change, Contributors to EBITDA Margin Change, and EBITDA to Net Income.

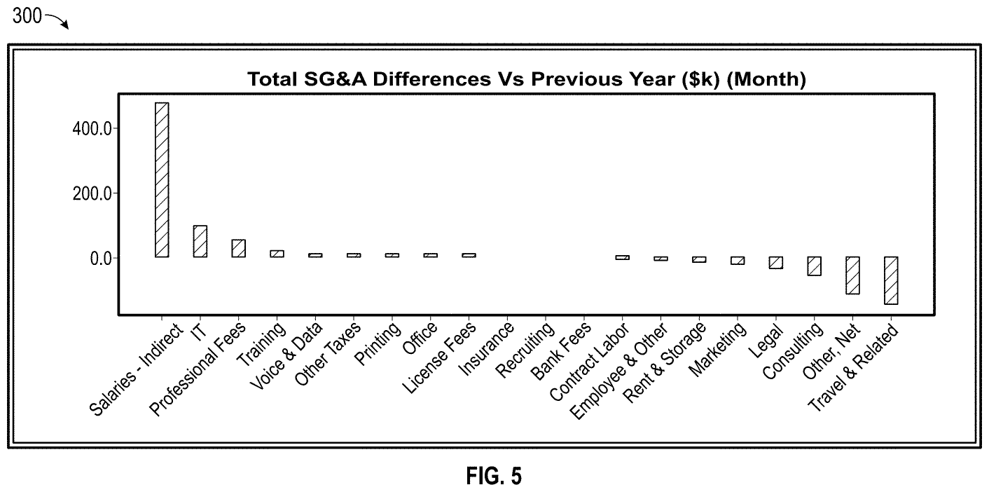

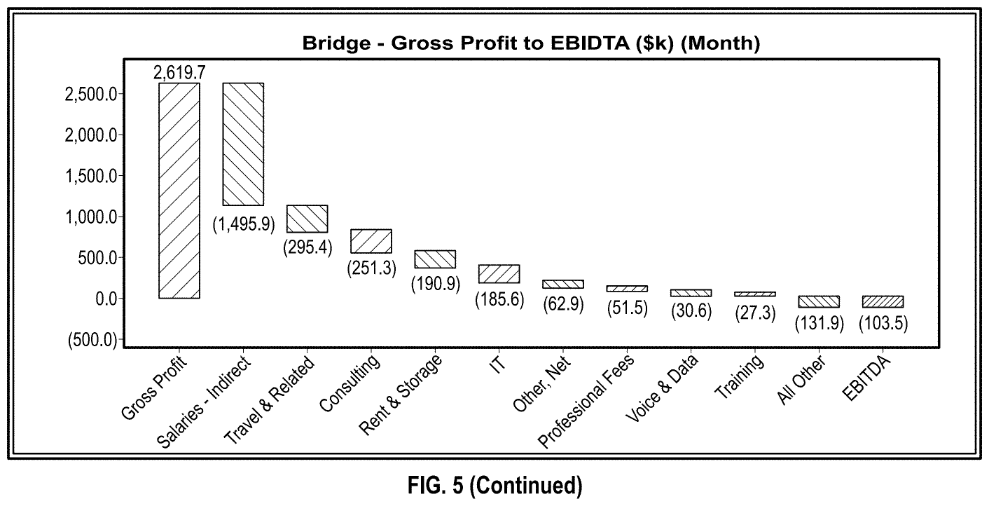

As another example, FIG. 5 depicts charts that may further be included in report 300. FIG. 5 shows a first chart that depicts the total SG&A differences versus the previous year. This chart identifies which SG&A (or overheads) are the most representative and can also be used to implement cost saving initiatives by focusing cost saving efforts on the largest cost categories). FIG. 5 also shows a bridge chart for gross profit (sales minus cost of sales) to EBITDA (profits).

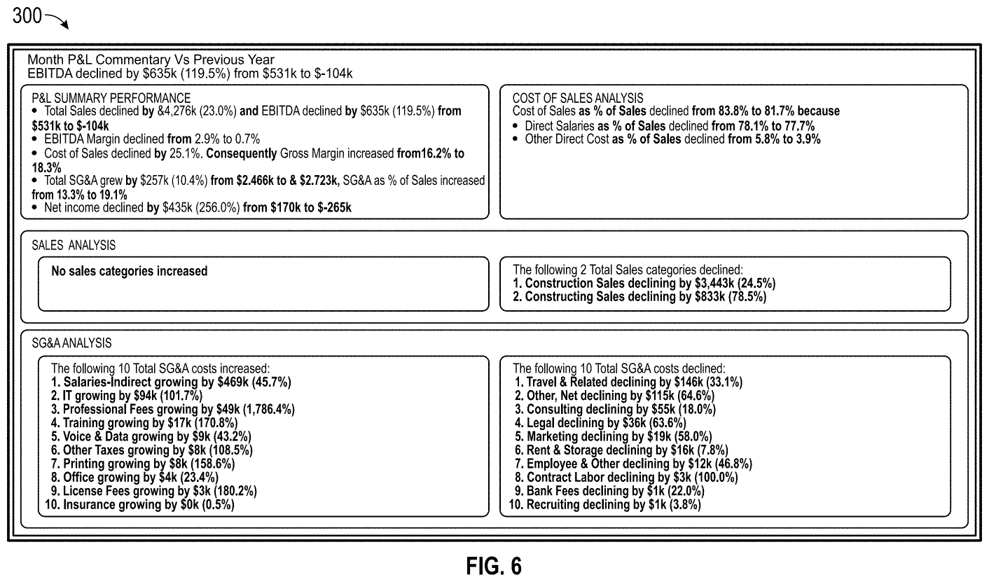

FIG. 6 provides an exemplary embodiment of commentary on a profits and loss (P&L) (for the month and year-to-date period). As shown in FIG. 6, report 300 may include a P&L summary performance. Using advance analytics and AI algorithms, AI financial analysis and reporting platform 110 may provide a written summary of financial performance and provides a written explanation of how certain profit and loss categories/and subcategories have performed/evolved (e.g., sales, cost of sales as percentage of sales, SG&A, etc.).

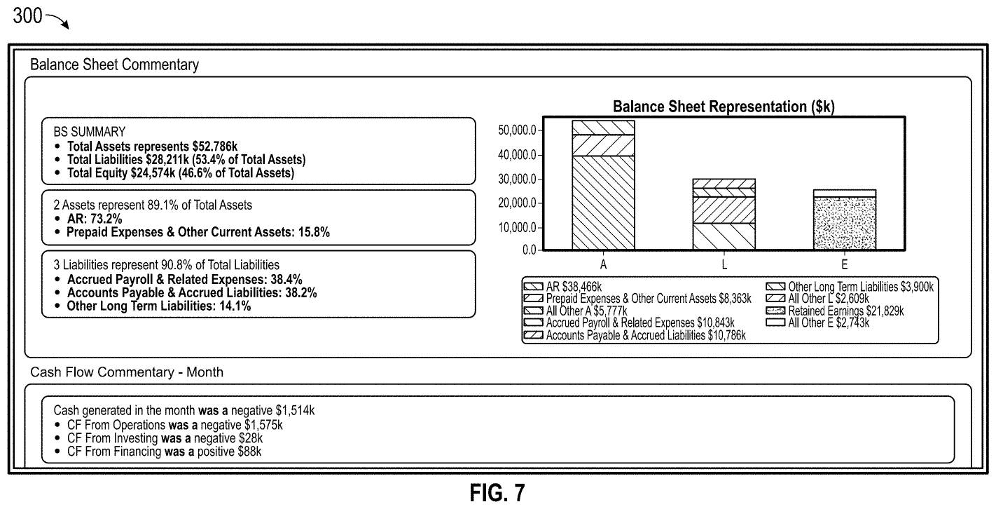

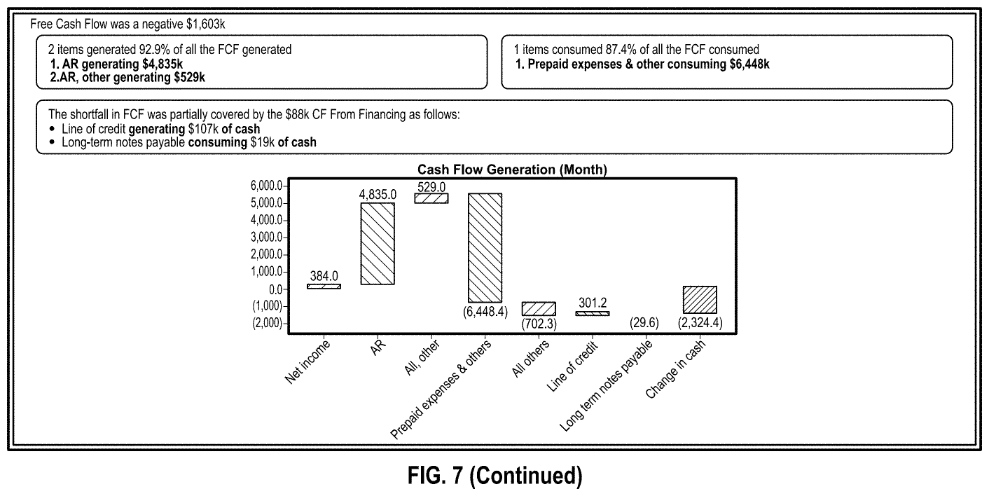

FIG. 7 provides an exemplary embodiment of balance sheet commentary. FIG. 7 shows graphically in a breakdown of a balance sheet (e.g., assets, liabilities, and equity). FIG. 7 includes explanations of the main components of the balance sheet. To help further illustrate, AI financial analysis and reporting platform 110 uses algorithms to identify assets (liabilities) that make up to 85% of the total assets (liabilities). In addition, once identified these assets (liabilities) may be described in writing and displayed in a chart with all other assets (liabilities) categorized as “All Other Assets (All Other Liabilities)”. For example, as shown in FIG. 7, two assets represent 89.1% of total assets, accounts receivable (AR) is 73.2%, and prepaid expenses and other current assets is 15.8%. As another example, as shown in FIG. 7, 3 liabilities represent 90.8% of total liabilities, accrued payroll and related expenses is 38.4%, accounts payable and accrued liabilities is 38.2%, and other long term liabilities is 14.1%.

In addition, FIG. 7 provides an exemplary embodiment of cash flow commentary (e.g., for the month and year-to-date period). Using advanced analytics and AI algorithms, AI financial analysis and reporting platform 110 generates an explanation and a chart to indicate how the entity has generated or consumed cash. As depicted in FIG. 7, AI financial analysis and reporting platform 110 generates report 300 to explain how much cash has been generated or consumed with (i) the operations of the entity, (ii) investments (e.g., buying machines), and (iii) financing (e.g., borrowing or repaying debt). As shown in FIG. 7, an example of this explanation includes the following: Cash generated in the month was a negative $1,514 k, cash flow (CF) from operations was a negative $1,575 k, CF from investing was a negative $28 k, and CF from financing was a positive $88 k.

FIG. 7 also includes commentary that explains which items have consumed (generated) most of the cash. AI financial analysis and reporting platform 110 identifies the items that have consumed (generated) up to 85% of all the free cash flow consumed (generated) and generates an explanation and a chart (free cash flow is defined as CF from operations minus CF from investing) indicating the findings of this analysis. As shown in FIG. 7, examples of this explanation may include: two items generated 92.0% of all the FCF generated, which was AR generating $12,978 k and other working capital (WC) generating $2,223 k. Further, as shown in FIG. 7, three items consumed 92.5% of all the FCF consumed, which are AP & accrued liabilities consuming $6,642 k, prepaid expenses and other consuming $6,610 k, and accrued payroll and related consuming $2,319 k. Finally, FIG. 7 includes a section explaining in writing how cash from financing (e.g., banks and shareholders) has been generated or consumed. For example, in FIG. 7, the $803 k shortfall in CF from financing is added to the shortfall in FCF as follows: line of credit generating $107 k of cash, short-term notes payable consuming $564 k of cash, and long-term notes payable consuming $346 k of cash.

In some embodiments, AI financial analysis and reporting platform 110 may use a machine learning model to change structure of the sentences included in the commentary in FIGS. 3-7 so that the explanation is appropriate to the financial situation represented by the financial data and so the color coding changes accordingly. For example, the structure of the sentence may be different from the example described above if cash from financing added to the cash consumption from free cash flow or if it compensated the consumption of cash from free cash flow. Example of two possible sentences explaining this scenario include: “The shortfall in FCF was partially covered by the $88 k CF from financing as follows.” or “The $803 k shortfall in CF from financing added to the shortfall in FCF as follows.”

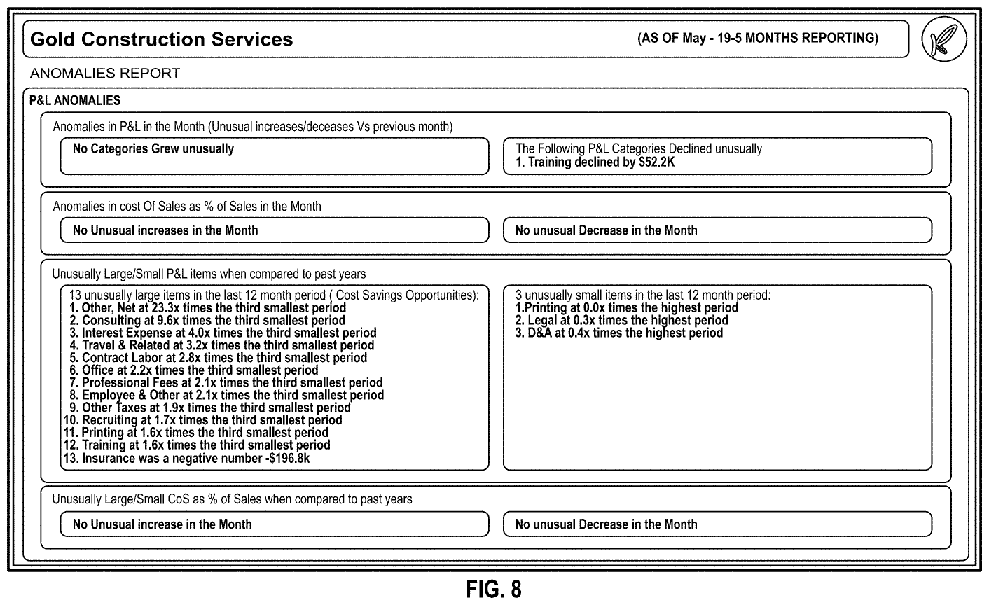

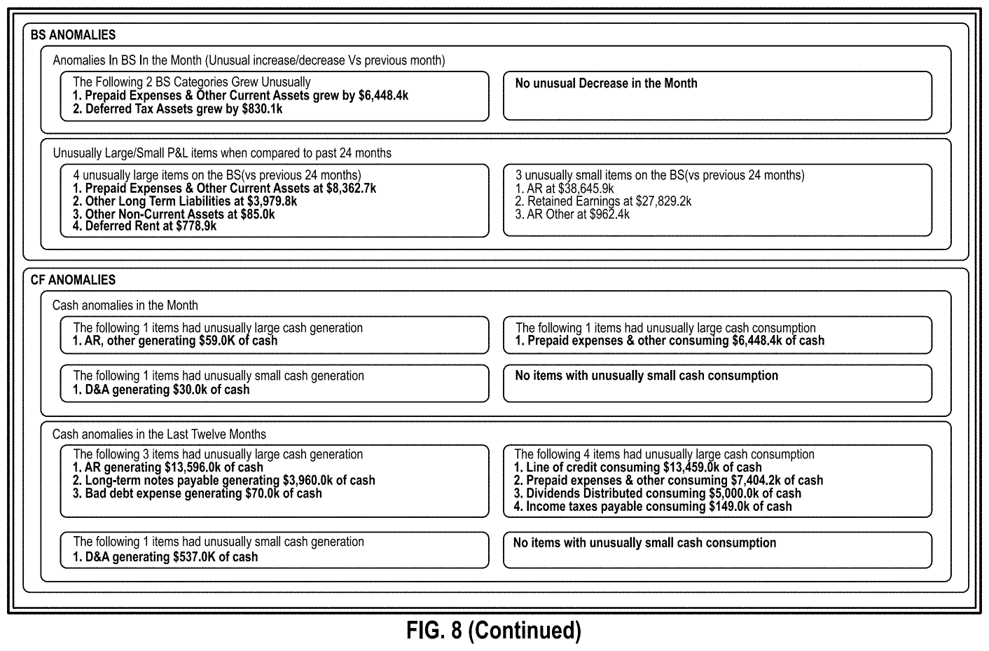

FIGS. 8-12 provide exemplary embodiments of additional reports generated by AI financial analysis and reporting platform 110. Each of the reports may be dynamically generated to include certain graphical user interface elements (e.g., charts, text, etc.) based on preferences, trends, anomalies, etc. AI financial analysis and reporting platform agent 112 may provide the report to user interface 106 to be displayed for a user of computing device 118. For example, FIG. 8 provides an exemplary embodiment of anomalies report. Using advanced analytics and AI algorithms, AI financial analysis and reporting platform 110 identifies two types of anomalies in profits and losses, balance sheets, and cash flow statements. The two types of anomalies are: monthly anomalies. For example, AI financial analysis and reporting platform 110 may determine unusual increases/decreases (e.g., that satisfy a threshold) from one month to the next in each financial category. As depicted in FIG. 8, “The Following P&L Categories Declined Unusually: Training declined by $52.2 k” or “The Following 2 BS Categories Grew Unusually: 1—Prepaid Expenses & Other Current Assets grew by $6,448.4 k, 2—Deferred Tax Assets grew by $830.1 k. In addition, AI financial analysis and reporting platform 110 may Identify unusually large or small items when compared to previous periods (e.g., consulting expense are unusually large when compared to previous periods or receivables are unusually small when compared to previous periods). In some embodiments, anomalies may be detected by using time series analysis. Additionally, a particular value of the financial parameter may be determined to be an anomaly by using a normal distribution of the financial parameter and, for example, any values outside a number of standard deviations from the mean may be determined to be an anomaly.

FIG. 9 provides an exemplary embodiment of the results of a “What-ifs/Scenario” Analysis. What-if analysis is used to explore and compare various scenarios for an entity and determine alternatives for the entity based on changing certain financial parameters. In some embodiments, causal inference may be implemented that simulates and/or forecasts certain scenarios by changing one or more financial parameters, and determining whether a result changes, either positively or negatively. For example, using advance analytics and AI, AI financial analysis and reporting platform 110 is configured to inform, using commentary and a matrix in FIG. 9, a user how much profits for an entity would have increased if the entity had been able to increase profits, reduce cost of sales, or reduce overheads. For example, in FIG. 9, a user may be informed that “If your Prices had been 1.0% higher and your CoS had been 1.0% lower, your Previous Year EBITDA would have been $8,034 k (66.6%) higher (i.e. $20,100 k)”.

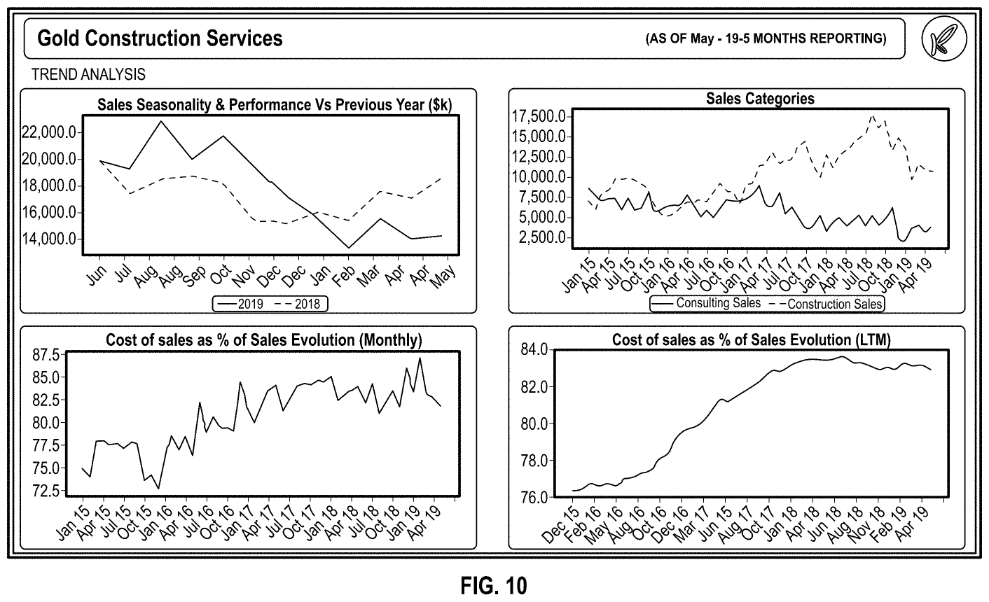

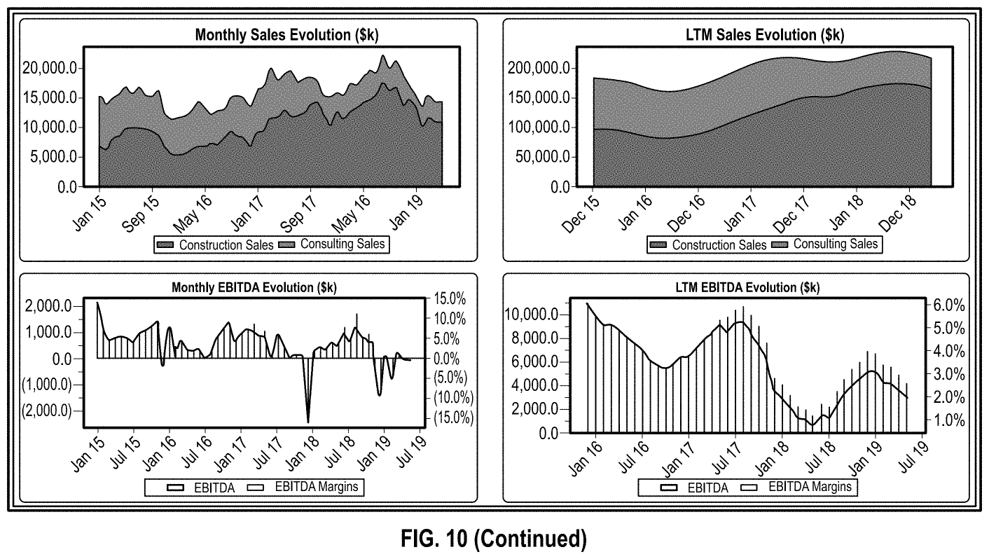

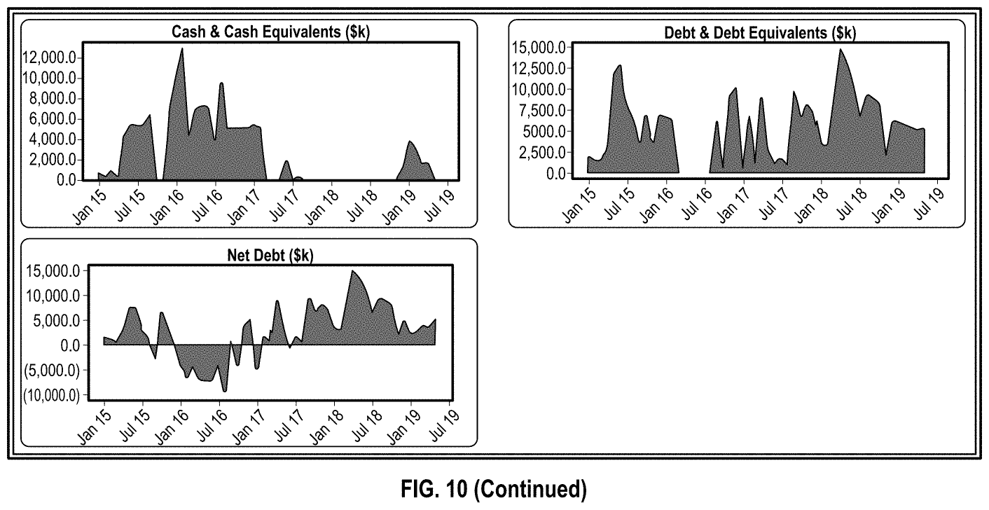

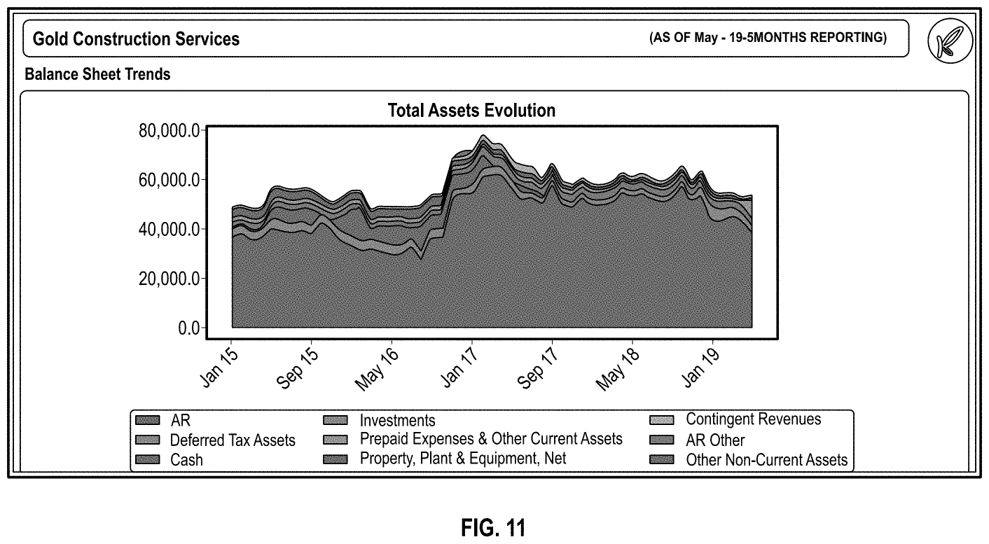

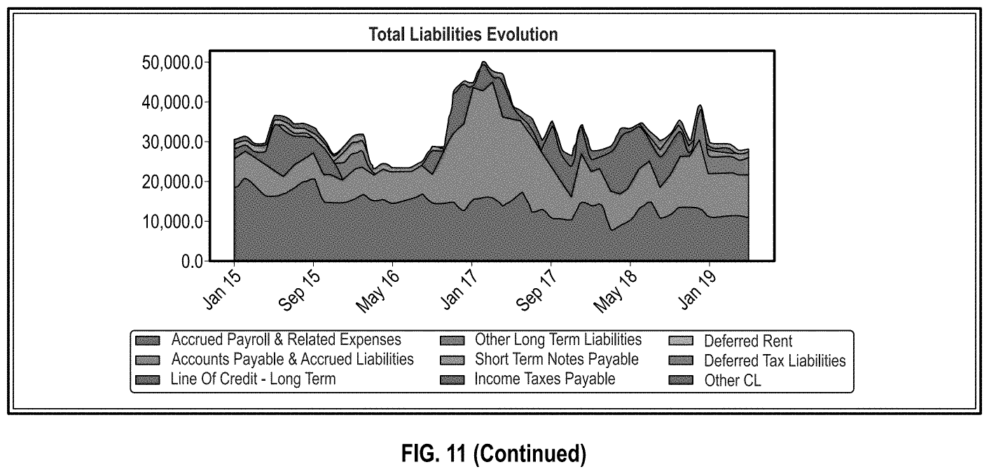

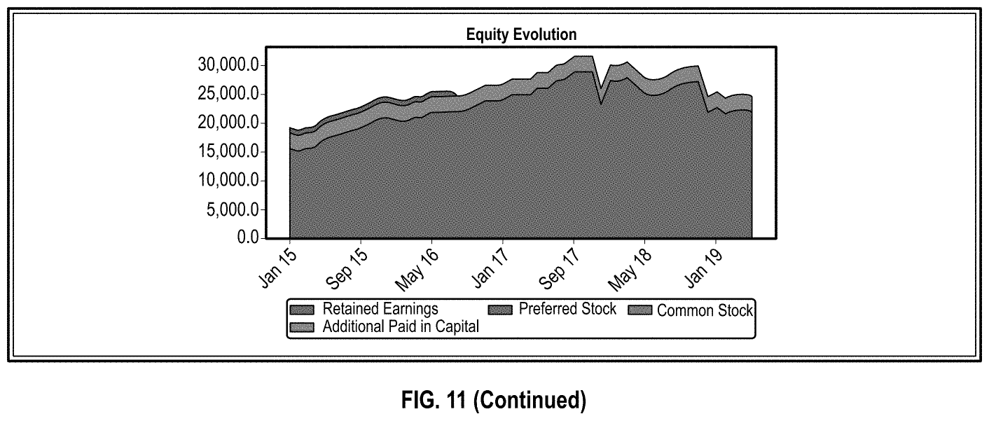

FIGS. 10 and 11 provides an exemplary embodiment of a summary of trend analysis performed by AI financial analysis and reporting platform 110. For example, AI financial analysis and reporting platform 110 may generate a set of trend charts which may present profits month by month and profits over the LTM period. Trend charts may depict trends in sales, cost of sales as percentage of sales, profits (EBITDA), cash, debt, and net debt (debt minus cash), historic break-down of assets, historic break-down of liabilities and historic break-down of equity. As shown in FIG. 11, trend charts may indicate balance sheet trends such as total assets evolution, total liabilities evolution, and equity evolution.

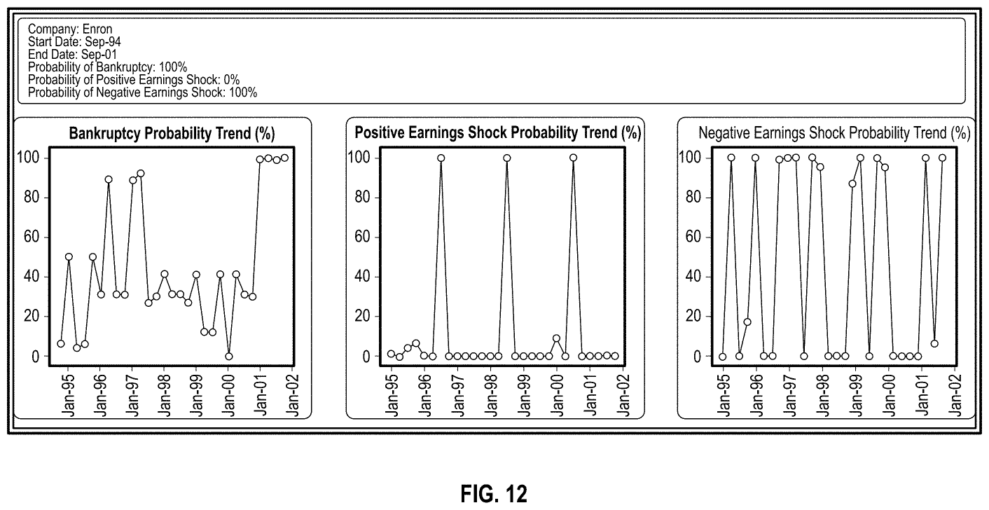

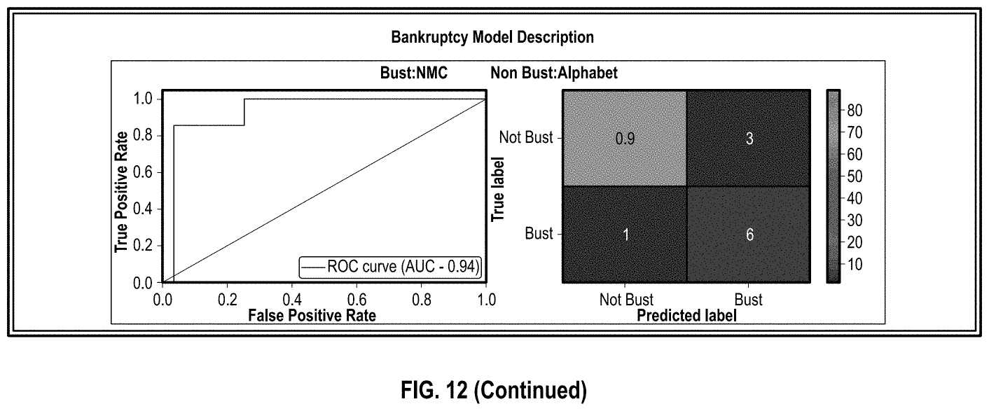

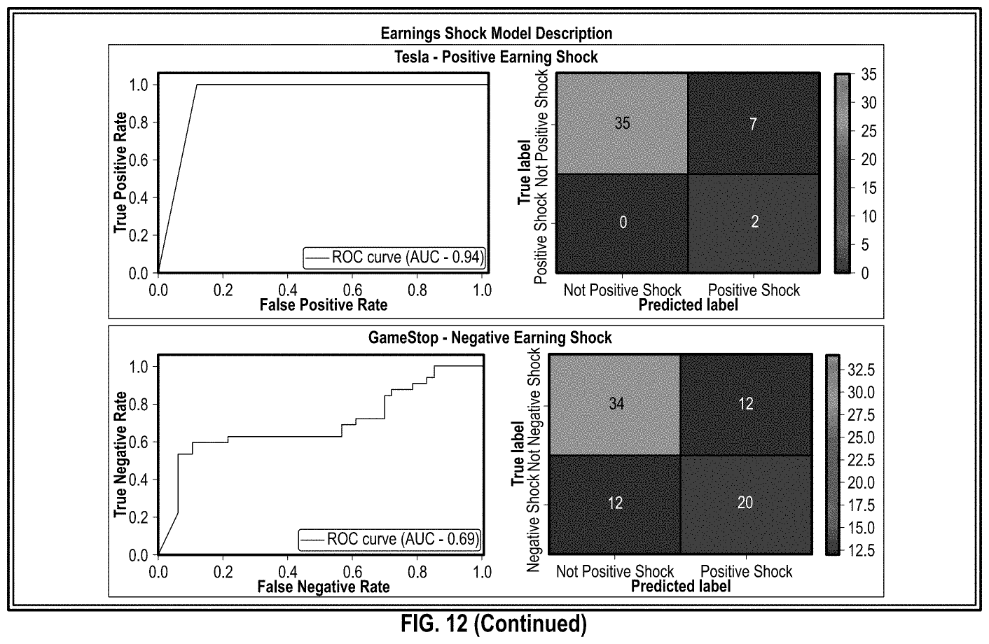

FIG. 12 provides an exemplary embodiment of a bankruptcy and earnings shock report. Using machine learning, AI financial analysis and reporting platform 110 provides trend charts of probability of bankruptcy and earnings shock over time. This analysis and charts can be used to predict bankruptcy/financial distress as well as to predict positive or negative earnings surprises.

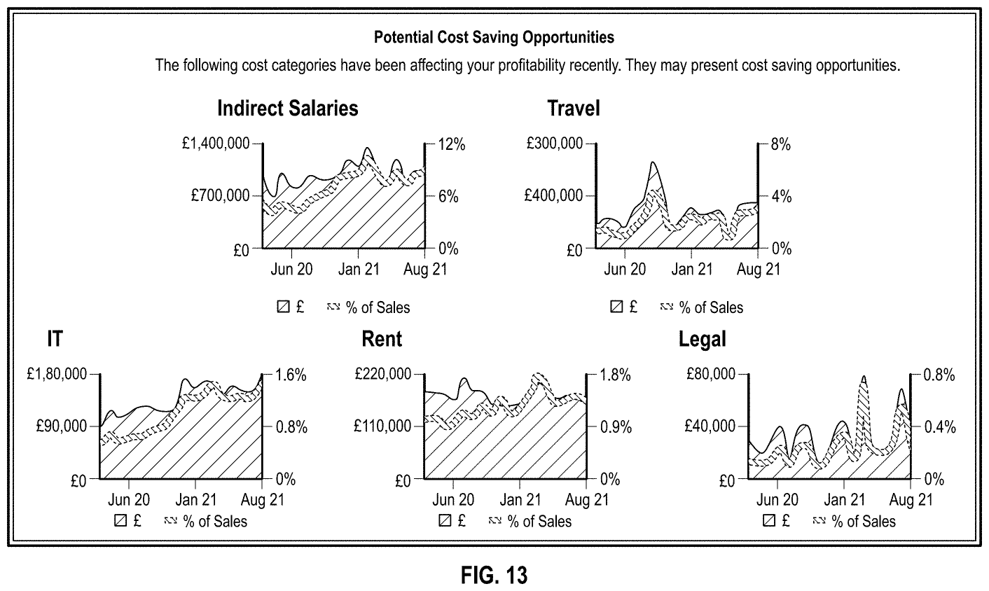

FIG. 13 provides an exemplary embodiment of a summary of potential cost saving opportunities analysis performed by AI financial analysis and reporting platform 110. For example, AI financial analysis and reporting platform 110 may identify one or more cost categories that are affecting the financial performance of the entity and transmit a notification to a computing device associated with the entity, where the notification includes an indication of one or more cost saving opportunities. For example, as shown in FIG. 13, the AI financial analysis and reporting platform may provide an enhanced graphical user interface to an application (e.g., stand-alone or executing within a web browser) executing on a computing device of a user. In FIG. 13, the graphical user interface displays different cost saving opportunities (e.g., indirect salaries, travel, IT, rent, legal, etc.) and the percentage the cost categories are of sales.

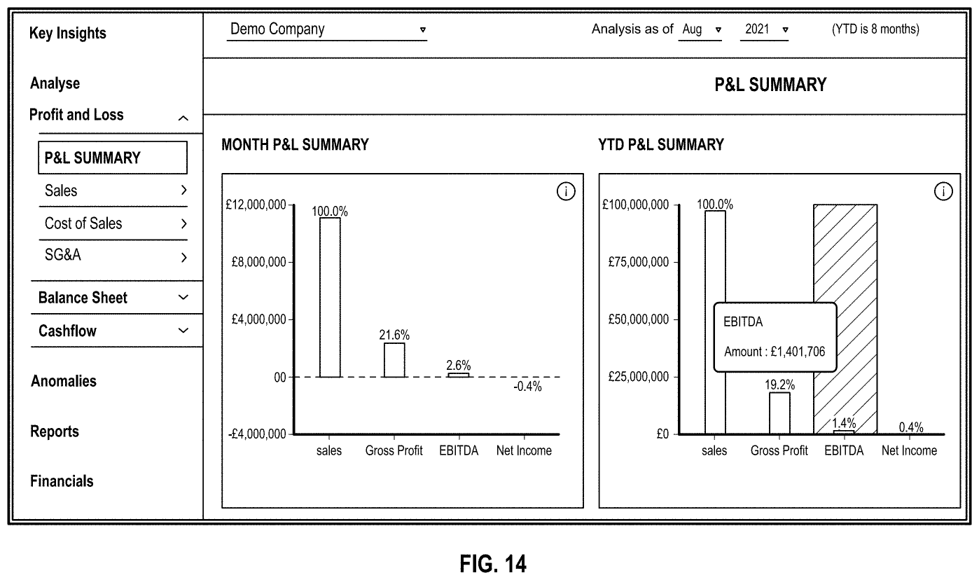

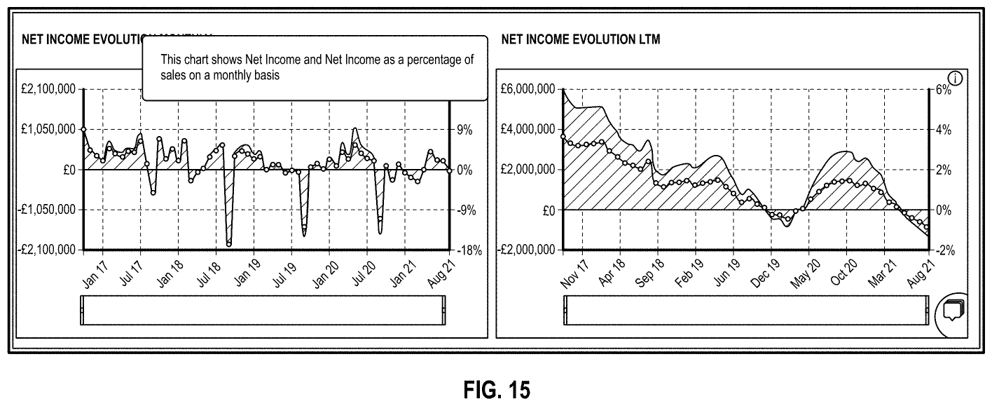

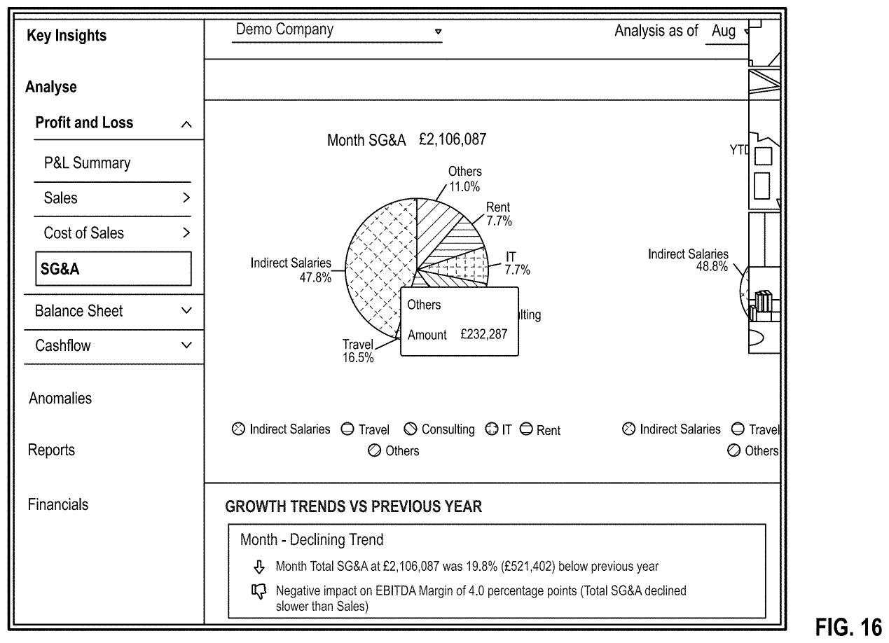

As described, AI financial analysis and reporting platform 110 may generate a report including a summary of the analysis. For example, a report may utilize color coding in charts and written explanations, such as red/orange to indicate bad and green/blue to indicate good. In some embodiments, a user graphical interface (e.g., user interface 106) may include a dashboard that a user can use to drill down into financial data associated with an entity. For example, FIGS. 14-17 provide exemplary embodiments of a graphical user interface for reviewing financial data associated with the entity. For example, in FIG. 14, a user may interact with the dashboard to review different aspects of an analysis (e.g., profit and loss, balance sheet, cashflow, etc.). The user may use the dashboard in FIG. 14 to drill down into financial data associated with the entity. Additionally, the user may click on parts of the charts or graphs to link to other aspects of the analysis and to display additional information about the analysis. For example, as shown in FIG. 15, the user may interact with the user interface to prompt an explanation of the graph to display. FIG. 16 provides another exemplary embodiment of a graphical user interface for reviewing financial data associated with the entity.

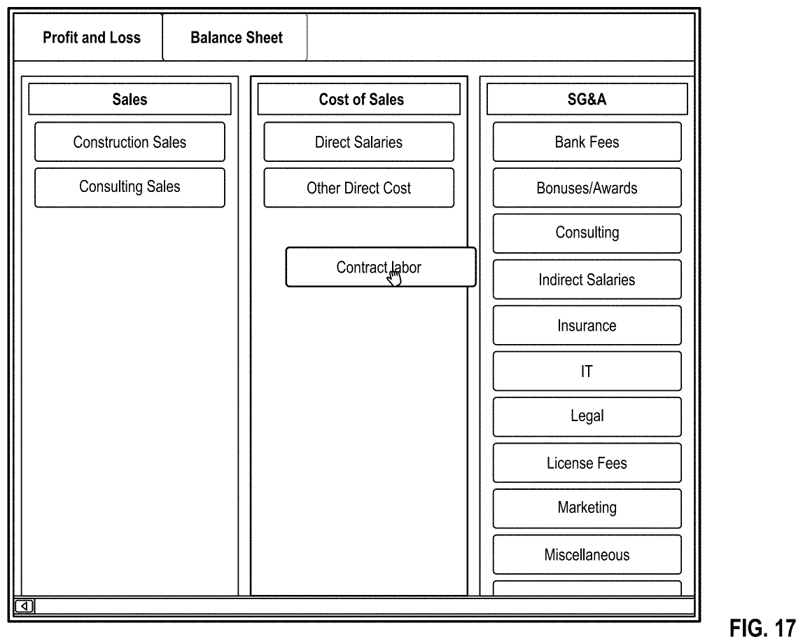

FIG. 17 provides an exemplary embodiment of a graphical user interface for classifying the financial data into different financial categories. For example, as shown in FIG. 17, the user may drag and drop financial data (e.g., contract labor) into different financial categories that the financial data is relevant to. AI financial analysis and reporting platform 110 may analyze the financial data and other financial data associated with the financial category and update the analysis on the financial performance of the entity based on the categorization of the financial data.

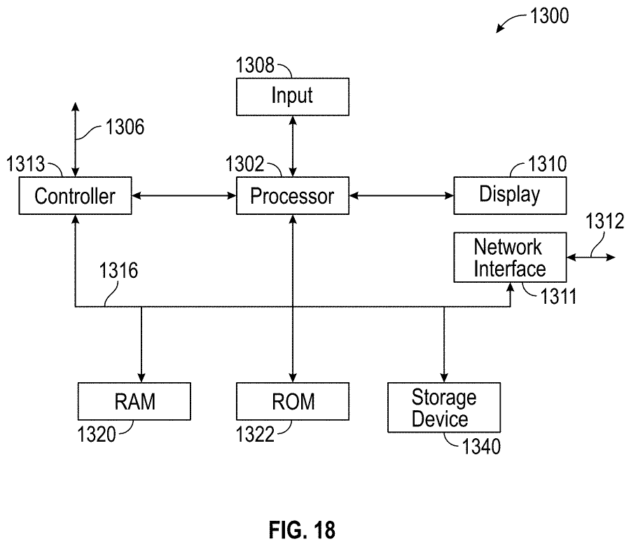

FIG. 18 illustrates a detailed view of a computing device 1300 that can be used to implement the various components described herein, according to some embodiments. In particular, the detailed view illustrates various components that can be included client computing device 118 and AI financial analysis and reporting platform 110 as illustrated in FIG. 1. As shown in FIG. 18, the computing device 1300 can include a processor 1302 that represents a microprocessor or controller for controlling the overall operation of the computing device 1300. The computing device 1300 can also include a user input device 1308 that allows a user of the computing device 1300 to interact with the computing device 1300. For example, the user input device 1308 can take a variety of forms, such as a button, keypad, dial, touch screen, audio input interface, visual/image capture input interface, input in the form of sensor data, and so on. Still further, the computing device 1300 can include a display 1310 that can be controlled by the processor 1302 to display information to the user. A data bus 1316 can facilitate data transfer between at least a storage device 1340, the processor 1302, and a controller 1313. The controller 1313 can be used to interface with and control different equipment through an equipment control bus 1306. The computing device 1300 can also include a network/bus interface 1311 that couples to a data link 1312. In the case of a wireless connection, the network/bus interface 1311 can include a wireless transceiver.

As noted above, the computing device 1300 also includes the storage device 1340, which can comprise a single disk or a collection of disks (e.g., hard drives), and includes a storage management module that manages one or more partitions within the storage device 1340. In some embodiments, storage device 1340 can include flash memory, semiconductor (solid-state) memory or the like. The computing device 1300 can also include a Random-Access Memory (RAM) 1320 and a Read-Only Memory (ROM) 1322. The ROM 1322 can store programs, utilities or processes to be executed in a non-volatile manner. The RAM 1320 can provide volatile data storage, and stores instructions related to the operation of processes and applications executing on the computing device.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computerreadable medium include read-only memory, random-access memory, CD-ROMs, DVDs, magnetic tape, hard disk drives, solid-state drives, and optical data storage devices. The computer readable medium can also be distributed over network-coupled computer systems so that the computer readable code is stored and executed in a distributed fashion.

Consistent with the above disclosure, the examples of systems and method enumerated in the following clauses are specifically contemplated and are intended as a non-limiting set of examples.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid-state drives, and optical data storage devices. The computer readable medium can also be distributed over network-coupled computer systems so that the computer readable code is stored and executed in a distributed fashion.

Consistent with the above disclosure, the examples of systems and method enumerated in the following clauses are specifically contemplated and are intended as a non-limiting set of examples.

### Clauses

A computer-implemented method performed by an artificial intelligence (AI) financial analysis and reporting platform, the method comprising: receiving financial data associated with an entity, the financial data being in a first format of an accounting system of the entity; transforming the financial data from the first format to a second format of the AI financial analysis and reporting platform; analyzing a first set of financial data from a first period of time to compare the first set of financial data to a second set of financial data from a second period of time, wherein the first set of financial and the second set of financial data comprises data from the received financial data; and generating a report on a financial performance of the entity, the report including an explanation of differences between the first set of financial data and the second set of financial data.

The computer-implemented method of claim 1, the method further comprising analyzing the financial data to identify trends in the financial data and wherein the report includes an explanation of the trends in the financial data, wherein the trends include an evolution in time in financial categories.

The computer-implemented method of claim 1, the method further comprising analyzing the financial data to detect anomalies in the financial data and wherein the report includes an explanation of the anomalies.

The computer-implemented method of claim 1, the method further comprising: training, based on financial information from other companies, a bankruptcy/financial distress prediction model; applying the financial data to the bankruptcy/financial distress prediction model; and receiving, from the bankruptcy/financial distress prediction model, an indication that the entity exceeds a threshold probability of experiencing bankruptcy or financial distress.

The computer-implemented method of claim 4, the method further comprising updating, based on the financial data, the bankruptcy/financial distress prediction model.

The computer-implemented method of claim 4, the method further comprising generating, in response to receiving the indication, recommendations for the entity to avoid bankruptcy or financial distress and wherein the report includes the recommendations.

The computer-implemented method of claim 1, the method further comprising generating recommendations to improve the financial performance and status of the entity and wherein the report includes the recommendations.

The computer-implemented method of claim 1, further comprising: connecting to one or more application programming interfaces (APIs) of one or more accounting systems, wherein the one or more APIs and the one or more accounting systems are hosted on one or more servers that are different than a server hosting the AI financial analysis and reporting platform; and performing one or more function calls to one or more services exposed by the one or more APIs to receive the financial data associated with the entity.

The computer-implemented method of claim 8, wherein transforming the financial data from the first format to the second format of the AI financial analysis and reporting platform further comprises: performing one or more function calls to one or more services exposed by the one or more APIs to receive a plurality of data schemas including a plurality of formats used by the one or more accounting systems; mapping, using a first trained machine learning model, the plurality of schemas including the plurality of formats to a generic schema including a generic format; and mapping, using a second trained machine learning model, the generic schema including the generic format to a schema including the second format of the AI financial analysis and reporting platform.

The computer-implemented method of claim 1, further comprising: generating the explanation of the differences between the first set of financial data and the second set of financial data, wherein: the explanation of the differences is generated based on the comparison of the first set of financial data to the second set of financial data associated with the entity from the second period of time, and based on the differences identified during the comparison, the explanation of the differences is generated automatically using a plurality of template sentences, phrases, words, constructs, or some combination thereof.

The computer-implemented method of claim 1, further comprising: determining when a data point or a difference of the differences qualifies as an anomaly; and transmitting a notification to a computing device associated with the entity, wherein the notification includes a description of the anomaly and provides suggestions as to how to react to the anomaly.

The computer-implemented method of claim 1, further comprising: generating the report by: selecting graphical user interface elements representing trends, anomalies, or some combination thereof, wherein the trends include an evolution in time in financial categories, and the anomalies include a deviation from a mean of historical financial data in the financial categories; generating the graphical user interface elements to represent data based on the differences between the first set of financial data and the second set of financial data; and causing the graphical user interface elements to be presented on a single user interface of the AI financial analysis and reporting platform.

The computer-implemented method of claim 1, wherein the second period of time is a same period of time as the first period of time but of a previous year.

The computer-implemented method of claim 1, wherein the report further includes any of the following: an explanation of the financial performance and status of the entity during the first period of time, an explanation of differences in the financial performance of the entity between the first period of time and the second period of time, and budget information of the entity for first period of time.

The computer-implemented method of claim 1, wherein the first period of time is a period of time selected by a user.

The computer-implemented method of claim 3, wherein the anomalies further include a spike up or down in data associated with a particular financial category of the financial categories or a fluctuation in data associated with the particular financial category from different periods of time.

The computer-implemented method of claim 1, further comprising: identifying a cost category that is affecting the financial performance of the entity; and transmitting a notification to a computing device associated with the entity, wherein the notification includes an indication of the cost category.

The computer-implemented method of claim 1, further comprising: classifying the first set of financial data into a financial category; analyzing the first set of financial data and other financial data associated with the financial category; and updating the report on the financial performance of the entity based on the analysis of the first set of financial data and the other financial data associated with the financial category.

An artificial intelligence (AI) financial analysis and reporting platform comprising: a memory device containing stored instructions; and a processing device communicatively coupled to the memory device, wherein the processing device executes the stored instructions to: receive financial data associated with an entity, the financial data being in a first format of an accounting system of the entity; transform the financial data from the first format to a second format of the AI financial analysis and reporting platform; analyze a first set of financial data from a first period of time to compare the first set of financial data to a second set of financial data from a second period of time, wherein the first set of financial and the second set of financial data comprises data from the received financial data; and generate a report on a financial performance of the entity, the report including an explanation of differences between the first set of financial data and the second set of financial data.

A computer readable media storing instructions that are executable by a processor to cause a processing device to execute operations comprising: receive financial data associated with an entity, the first set of financial data being in a first format of an accounting system of the entity; transform the financial data from the first format to a second format of an AI financial analysis and reporting platform; analyze a first set of financial data from a first period of time to compare the first set of financial data to a second set of financial data from a second period of time, wherein the first set of financial and the second set of financial data comprises data from the received financial data; and generate a report on a financial performance of the entity during the first period of time, the report including an explanation of differences between the first set of financial data and the second set of financial data.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A computer-implemented method performed by an artificial intelligence (AI) financial analysis and reporting platform, the method comprising:
receiving financial data associated with an entity, the financial data being in a first format of an accounting system of the entity;
transforming the financial data from the first format to a second format of the AI financial analysis and reporting platform;
analyzing a first set of financial data from a first period of time to compare the first set of financial data to a second set of financial data from a second period of time, wherein the first set of financial and the second set of financial data comprises data from the received financial data; and
generating a report on a financial performance of the entity, the report including an explanation of differences between the first set of financial data and the second set of financial data.

2. The computer-implemented method of claim 1, the method further comprising analyzing the financial data to identify trends in the financial data and wherein the report includes an explanation of the trends in the financial data, wherein the trends include an evolution in time in financial categories.

3. The computer-implemented method of claim 1, the method further comprising analyzing the financial data to detect anomalies in the financial data and wherein the report includes an explanation of the anomalies.

4. The computer-implemented method of claim 1, the method further comprising:
training, based on financial information from other companies, a bankruptcy/financial distress prediction model;
applying the financial data to the bankruptcy/financial distress prediction model; and
receiving, from the bankruptcy/financial distress prediction model, an indication that the entity exceeds a threshold probability of experiencing bankruptcy or financial distress.

5. The computer-implemented method of claim 4, the method further comprising updating, based on the financial data, the bankruptcy/financial distress prediction model.

6. The computer-implemented method of claim 4, the method further comprising generating, in response to receiving the indication, recommendations for the entity to avoid bankruptcy or financial distress and wherein the report includes the recommendations.

7. The computer-implemented method of claim 1, the method further comprising generating recommendations to improve the financial performance and status of the entity and wherein the report includes the recommendations.

8. The computer-implemented method of claim 1, further comprising:
connecting to one or more application programming interfaces (APIs) of one or more accounting systems, wherein the one or more APIs and the one or more accounting systems are hosted on one or more servers that are different than a server hosting the AI financial analysis and reporting platform; and
performing one or more function calls to one or more services exposed by the one or more APIs to receive the financial data associated with the entity.

9. The computer-implemented method of claim 8, wherein transforming the financial data from the first format to the second format of the AI financial analysis and reporting platform further comprises:
performing one or more function calls to one or more services exposed by the one or more APIs to receive a plurality of data schemas including a plurality of formats used by the one or more accounting systems;
mapping, using a first trained machine learning model, the plurality of schemas including the plurality of formats to a generic schema including a generic format; and
mapping, using a second trained machine learning model, the generic schema including the generic format to a schema including the second format of the AI financial analysis and reporting platform.

10. The computer-implemented method of claim 1, further comprising:
generating the explanation of the differences between the first set of financial data and the second set of financial data, wherein:
the explanation of the differences is generated based on the comparison of the first set of financial data to the second set of financial data associated with the entity from the second period of time, and
based on the differences identified during the comparison, the explanation of the differences is generated automatically using a plurality of template sentences, phrases, words, constructs, or some combination thereof.

11. The computer-implemented method of claim 1, further comprising:
determining when a data point or a difference of the differences qualifies as an anomaly; and
transmitting a notification to a computing device associated with the entity, wherein the notification includes a description of the anomaly and provides suggestions as to how to react to the anomaly.

12. The computer-implemented method of claim 1, further comprising:
generating the report by:
selecting graphical user interface elements representing trends, anomalies, or some combination thereof, wherein the trends include an evolution in time in financial categories, and the anomalies include a deviation from a mean of historical financial data in the financial categories;
generating the graphical user interface elements to represent data based on the differences between the first set of financial data and the second set of financial data; and
causing the graphical user interface elements to be presented on a single user interface of the AI financial analysis and reporting platform.

13. The computer-implemented method of claim 1, wherein the second period of time is a same period of time as the first period of time but of a previous year.

14. The computer-implemented method of claim 1, wherein the report further includes any of the following: an explanation of the financial performance and status of the entity during the first period of time, an explanation of differences in the financial performance of the entity between the first period of time and the second period of time, and budget information of the entity for first period of time.

15. The computer-implemented method of claim 1, wherein the first period of time is a period of time selected by a user.

16. The computer-implemented method of claim 3, wherein the anomalies further include a spike up or down in data associated with a particular financial category of the financial categories or a fluctuation in data associated with the particular financial category from different periods of time.

17. The computer-implemented method of claim 1, further comprising:
identifying a cost category that is affecting the financial performance of the entity; and
transmitting a notification to a computing device associated with the entity, wherein the notification includes an indication of the cost category.

18. The computer-implemented method of claim 1, further comprising:
classifying the first set of financial data into a financial category;
analyzing the first set of financial data and other financial data associated with the financial category; and
updating the report on the financial performance of the entity based on the analysis of the first set of financial data and the other financial data associated with the financial category.

19. An artificial intelligence (AI) financial analysis and reporting platform comprising:
a memory device containing stored instructions; and
a processing device communicatively coupled to the memory device, wherein the processing device executes the stored instructions to:
receive financial data associated with an entity, the financial data being in a first format of an accounting system of the entity;
transform the financial data from the first format to a second format of the AI financial analysis and reporting platform;
analyze a first set of financial data from a first period of time to compare the first set of financial data to a second set of financial data from a second period of time, wherein the first set of financial and the second set of financial data comprises data from the received financial data; and
generate a report on a financial performance of the entity, the report including an explanation of differences between the first set of financial data and the second set of financial data.

20. A computer readable media storing instructions that are executable by a processor to cause a processing device to execute operations comprising:
receive financial data associated with an entity, the first set of financial data being in a first format of an accounting system of the entity;
transform the financial data from the first format to a second format of an AI financial analysis and reporting platform;
analyze a first set of financial data from a first period of time to compare the first set of financial data to a second set of financial data from a second period of time, wherein the first set of financial and the second set of financial data comprises data from the received financial data; and
generate a report on a financial performance of the entity during the first period of time, the report including an explanation of differences between the first set of financial data and the second set of financial data.
